(19) United States
(12) Patent Application Publication
(10) Pub. No.: US 2002/0142075 A1
(43) Pub. Date: Oct. 3, 2002

(54) Liquid drinking assemblage and system

(76) Inventor: Robert E. Weinstein, Boston, MA (US)

Correspondence Address: MESMER & DELEAULT, PLLC, 41 BROOK STREET, MANCHESTER, NH, 03104, US

(21) Appl. No.: 09/819,550

(22) Filed: Mar. 27, 2001

(51) Int. Cl. A23B 4/00

(52) U.S. Cl. 426/120

(57) ABSTRACT

An assemblage for simultaneously ingesting more than one liquid beverage, having a plurality of individual conduits, a plurality of beverage receptacles, and a joining mechanism for joining said receptacles into a unified structure. The conduits, receptacles, and joining mechanism are of complementarily size and configuration such, that when the device is assembled, the conduits can reach from the furthest interior of its respective receptacle, through an outlet in said receptacle, and comfortably into a user's mouth.

### BACKGROUND OF THE INVENTION

1. Field of the Invention

The present invention relates to dispensers for potable liquids. Particularly, the present invention relates to an apparatus for conveying more than one liquid into the mouth discretely and simultaneously.

2. Description of the Prior Art

When eating solid foods, it is common to simultaneously place more than one food into the mouth, i.e. meat and potato on a fork. This practice allows the eater to combine foods to satisfy his or her personal tastes. By virtue of the integrity of solid food, it is also possible for the eater to place additional food in the mouth before swallowing. An example might be having meat in the mouth, then taking a bite of bread, chewing and swallowing both. This allows the eater to spontaneously combine foods in the mouth to suit his or her tastes.

Solid foods are commonly prepared in combination so that the taste and texture of each component is appreciated when they are eaten. Examples are innumerable: sandwiches consisting of bread and filling, pizzas which combine layers of dough, cheese, and topping, salads of multiple components, and pies and pastries made up of crust and filling. With these, the eater experiences the taste and the texture of the components individually as well as mixed together in the mouth.

Various attempts have been made in the past to couple multiple-component solid foods. U.S. Pat. No. 4,517,205 issued to Aldrich teaches a two-component hard candy and methods for making such a candy, U.S. Pat. No. 5,955,116 issued to Kehoe, et al. teaches a multi-flavored, multi-veined chewing gum having discrete areas of flavorants, colorants, ingredients or compositions, U.S. Pat. No. 5,437,879 issued to Kehoe, et al. teaches a multi-layered chewing gum to provide an initial delivery of multiple flavors and textures which harmoniously blend into a pleasant varied flavor, U.S. Pat. No. 6,083,546 issued to Carrick et al. teaches methods for preparing two component ice confections, and U.S Pat. No. 6,153,233 issued to Gordon, et al. teaches a solid food item which has different flavored layers. However, despite the size of the marketplace and the size of the manufactured food industry, none teaches a commercializable liquid beverage that allows the user to experience the liquid components discretely.

Devices for drinking liquid beverages are also known. U.S. Pat. No. 3,260,462, issued to Smaczny discloses a forked drinking straw having two legs and a central tube. Each leg is inserted into a different container and the liquids are mixed either in the central tube or in a mixing chamber located at the junction of the legs and central tube prior to reaching the mouth. Unlike mutli-component solid food, the Smaczny device mixes the beverage components prior to reaching the mouth.

U.S. Pat. No. 5,860,765 issued to Weinstein teaches a liquid drinking assemblage and system that employs joined conduits for enabling a person to ingest a plurality of liquids simultaneously from a plurality of containers into a plurality of oral locations. U.S. Pat. No. 6,032,873, also issued to Weinstein, discloses structural modifications of the conduits. A disadvantage of these devices is that the manufacture of joined conduits is more costly. Further, it requires additional dexterity to insert two or more joined conduits into two or more openings simultaneously. This is especially burdensome for users with impaired eye-hand coordination.

Taste buds of a single type are grouped together and located in particular areas of the mouth. To take advantage of the characteristics of various taste buds, it is desirable to direct different components of a beverage to different locations in the mouth. In contrast to solid foods, it is difficult to take in a second beverage while one is already in the mouth. A person takes a drink by either lifting the drink container to the mouth or by using a straw to draw the beverage into the mouth. In the former case, it is extremely difficult to take a second drink before swallowing the first mouthful. When the mouth is opened to take the second drink, the beverage already in the mouth will spill out. In the latter case, it is very awkward to try to put the straw back into the mouth before swallowing the first mouthful. Either the straw must be pushed between clenched lips or the head must be tilted backwards to keep the beverage from spilling out. One solution is to use two straws and two containers.

There are several disadvantages to this. First, one must find two straws that are appropriate relative to each other. They may not have the necessary diameters or lengths. In addition, because neither the straws nor the containers are joined together, it is awkward to keep them fixed relative to each other. For these reasons, individuals do not ordinarily drink combinations of liquid beverages so as to taste them discretely, akin to solid foods.

Therefore, what is needed is a device that allows a person to simultaneously direct several liquids to different locations in the mouth. What is further needed is a device that is easier to use than a device which requires simultaneously inserting a plurality of conduits into separate beverage receptacles. What is still further needed is a device that provides a user with a pre-packaged and pre-sealed combination of liquid beverages such that they may be discretely ingested simultaneously. What is yet further needed is a device that provides a user with a kit containing the elements of an assemblage which conveniently allows a person to experience individual liquids separately and then combined. What is also needed is a device that is less expensive than devices which require joined conduits.

### SUMMARY OF THE INVENTION

It is an object of the present invention to provide a mechanism that allows a person to simultaneously direct several liquids to different locations in the mouth. It is another object of the present invention to provide a device that is easier to use than a device which requires simultaneously inserting a plurality of conduits into separate beverage receptacles. It is still another object of the present invention to provide a user with a pre-packaged and pre-sealed combination of liquid beverages such that they may be discretely ingested simultaneously. It is yet another object of the present invention to provide a user with a kit containing the elements of an assemblage which conveniently allows a person to experience individual liquids separately and then combined. It is also another object of the present invention to provide a device that is less expensive than devices which require joined conduits.

The present invention achieves these and other objectives by providing a plurality of beverage receptacles, a joining mechanism for joining the receptacles into a unified structure, and a number of preselected and presized individual conduits. The configurations and dimensions of these elements are complementary so, that when assembled, the conduits can extend from the furthest reach of the interiors of the receptacles through an outlet in each receptacle to oral locations desired by the user. In particular, this requires conduits of predetermined longitudinal dimensions and containers of predetermined configuration. When the conduits are positioned from the furthest dependent interiors of the receptacles and through their outlets, the egresses of longitudinally rigid conduits would be positioned to fit into the mouth, or the egresses of longitudinally flexible or bendable conduits might be flexed or bent to fit into the mouth.

### BRIEF DESCRIPTION OF THE DRAWINGS

FIG. 1 is a perspective view of one embodiment of the present invention showing two receptacles joined by a receptacle joining piece.

FIG. 2 is a cross-sectional side view of the embodiment in FIG. 1.

FIG. 3 is a cross-sectional side view of another embodiment of the present invention showing two receptacles held by a receptacle receiving structure.

FIG. 4 is a top view of the receptacle receiving structure of FIG. 3.

FIG. 5 is a cross-sectional side view of another embodiment of the present invention showing two receptacles affixed to each other along their adjacent walls.

FIG. 6 is a top view of the embodiment shown in FIG. 5.

FIG. 7 is a side view of another embodiment of the present invention showing two receptacles that are unified by joining with one or more peripheral bands.

FIG. 8 is a top view of the embodiment shown in FIG. 7.

FIG. 9 is a side view of another embodiment of the present invention showing two receptacles that are unified by a casing.

FIG. 10 is a top view of the embodiment shown in FIG. 9.

FIG. 11 is a cross-sectional side view of another embodiment of the present invention showing two receptacles that are unified by a common wall.

FIG. 12 is a top view of the embodiment shown in FIG. 11.

FIG. 13 is a side view of another embodiment of the present invention showing two receptacles having a different volume.

FIG. 14 is a top view of the embodiment shown in FIG. 13.

FIG. 15 is a cross-sectional side view of another embodiment of the present invention showing two joined, collapsible receptacles.

### DETAILED DESCRIPTION OF THE PREFERRED EMBODIMENT

The preferred embodiment of the present invention is illustrated in FIGS. 1-15. The present invention has three basic elements: liquid beverage-containing receptacles which are prepackaged and sealed by a manufacturer for a user, a joining component for joining at least two receptacles into a unitary structure, and individual conduits, at least equal to the number of beverage containing receptacles. “Joining of the receptacles” means that they are physically positioned with regard to one another and, when together with their openings at the top, cannot easily be laterally separated by a user using moderate manual force. It is considered critical to the present invention that the receptacles, joining components and conduits are of complementarily configuration and size. This means that, when the device is assembled, the conduits can be positioned from the furthest dependant interiors of the receptacles, through the outlets of the receptacles and into locations within the mouth as desired by the user to access the sensory area desired for each beverage.

The intended use of the assemblage determines the various parameters of the assemblage, including the material of which the elements are composed, the dimensions of the receptacles, and the length, cross-section and flexibility of the conduits. Typically, each of the receptacles and conduits will have the same dimensions, although it is considered that differing beverage volumes might be advantageous in some situations. One example of such a situation may be to have a small quantity of liquid medication in a receptacle and a larger amount of beverage in a second receptacle to seamlessly “wash down” the medication after the medication is ingested. If the receptacles are of different dimensions, this would also require complementary conduit configuration to comply with the aforementioned parameters of the invention.

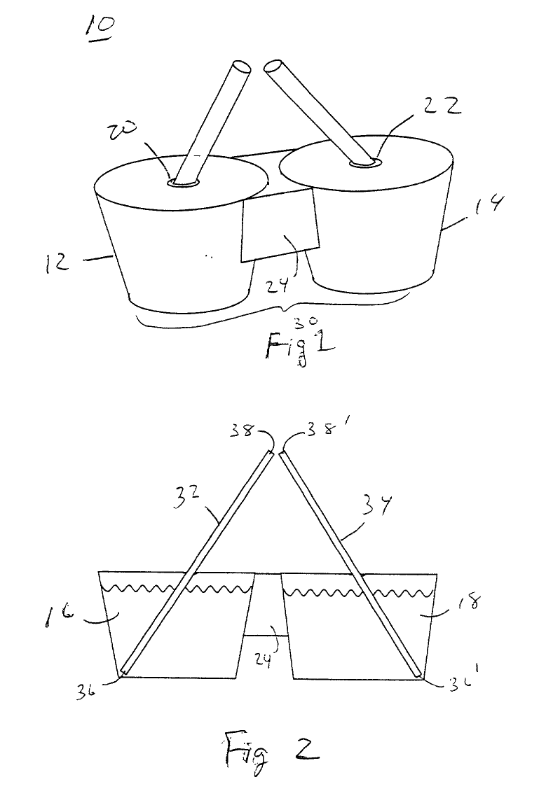

FIG. 1 is a perspective view of one embodiment of an assemblage 10 of the present invention. Assemblage 10 includes at least two receptacles 12 and 14 containing pre-filled beverages 16 and 18, as shown in FIG. 2, respectively, receptacle outlets 20 and 22, and a joining structure 24 that unifies the receptacles 12 and 14 into a unitary structure 30. FIG. 2 is a cross-sectional view of assemblage 10 shown in FIG. 1. Conduits 32 and 34 having an ingress 36, 36′ and egress 38, 38′, respectively, are inserted through the receptacle outlets 20 and 22. It is noted that the conduits can be positioned to extend from the most dependent, lateral aspect of the receptacles and be opposed at their opposite ends to fit into an individual's mouth. FIG. 3 shows an alternative configuration of the present invention where the joining structure 24 is a separate structure containing equal-sized wells 25 and 26 sized to receive receptacles 12 and 14, respectively. The receptacles may be placed in their relative position by the user's inserting them into wells 25 and 26 of joining structure 24. Alternatively, the receptacles 25 and 26 and joining structure 24 may be supplied to a user in an assembled state. As shown in FIG. 1, the joining structure 24 may be manufactured concomitantly with the receptacles, as, for example, being molded as a unitary entity. A variety of sizes and shapes of receptacles and complementary joining-piece structures are anticipated, however, a suitable size for the assemblage is considered to be commensurate with its being easily hand held and containing a conventional serving size for an individual. FIG. 4 shows a top view of joining structure 24 with receptacle wells 25 and 26.

FIG. 5 shows a cross-sectional side view of another embodiment of the present invention. Assemblage 50 includes two receptacles 52 and 56 containing beverages 54 and 58 and outlets 55 and 59, respectively. Receptacles 52 and 56 are adhered to each other using a bonding agent 60 between adjacent sides of receptacles 52 and 56. Bonding agent 60 may be one of a variety of adhesives or adhesive methods which are known in the art. FIG. 6 shows a top plan view of assemblage 50 showing receptacles 52 and 56, receptacle outlets 55 and 59, and bonding agent 60.

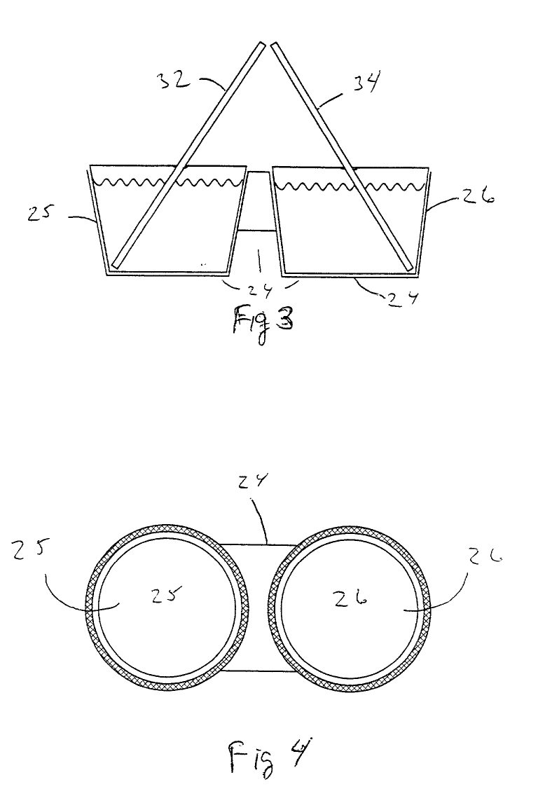

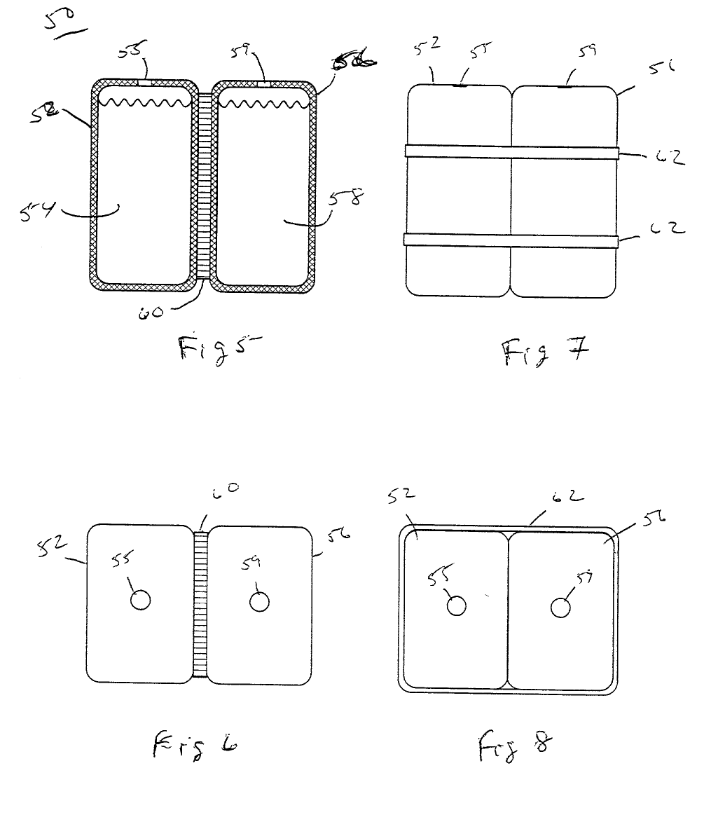

FIG. 7 illustrates a side view of another embodiment of the joining mechanism used to unify receptacles 52 and 56 of assemblage 50. Receptacles 52 and 56 are unified by peripheral banding 62. The joining of receptacles in this manner may be accomplished by a single band or multiple bands. FIG. 8 is a top plan view of assemblage 50 shown in FIG. 7. A wide variety of materials which include, but are not limited to cellophane, polyethylene, reinforced paper, and metal may be used for wrapping the periphery of receptacles 52 and 56.

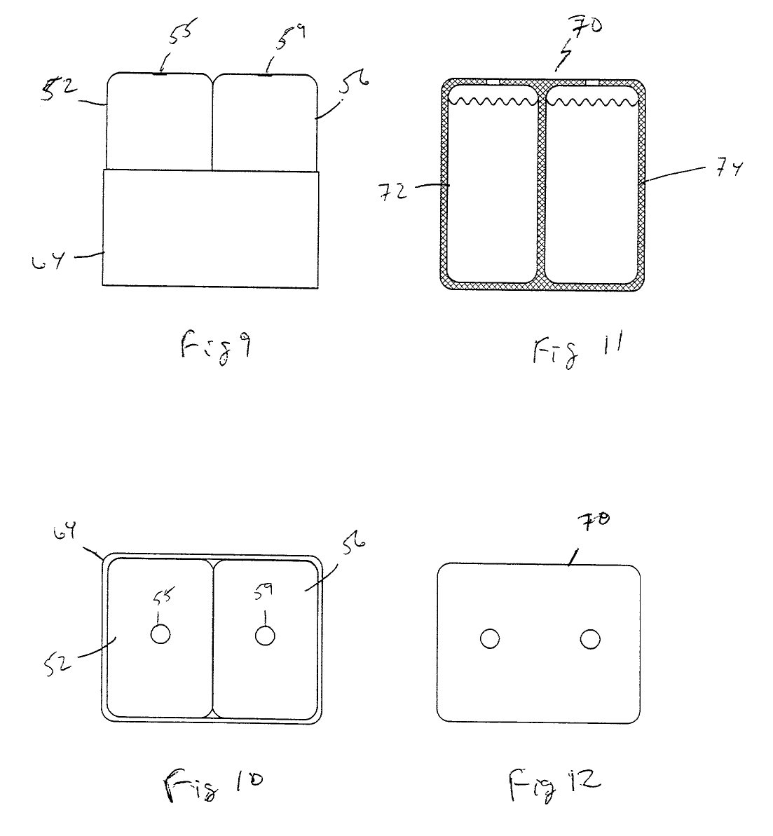

FIG. 11 illustrates a side view of another embodiment of the present invention showing two receptacles 52 and 56 that are unified by a joining piece which is in the form of a casing or container 64 into which both receptacles fit. In this case, the container 64 is in the shape of an open box which encloses the bottom half of both receptacles 52 and 56 to form a single, unified assemblage 50. Other coupling devices might be devised, such as one which encloses the tops and leaves space to access the outlets, or even one that encloses the entirety of the receptacles, but provides access to the outlets. FIG. 10 is a top plan view of the embodiment shown in FIG. 9.

FIG. 11 illustrates a cross-sectional side view of another embodiment of the present invention showing assemblage 70. Assemblage 70 includes two receptacles 72 and 74 which are unified by a common wall manufactured at the time of forming the two receptacles. Such receptacles might be formed from molded plastic or folded material. FIG. 12 illustrates a top plan view of the assemblage 70.

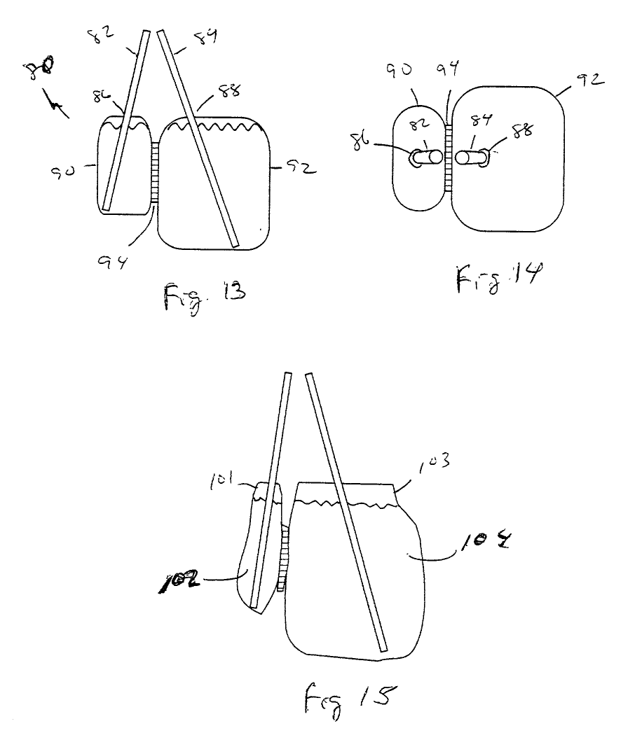

FIGS. 13-15 illustrate another embodiment of the present invention which may be adapted for dispensing medication. FIG. 13 illustrates a cross-sectional side view of an assemblage 80 in which conduits 82 and 84 have been inserted through the receptacle outlets 86 and 88 into receptacles 90 and 92, respectively. Notably the conduits 82 and 84 are of size complementary to the structure of the joined receptacles 90 and 92 such that they each reach the most dependent aspect of the receptacles and are oppose at their opposite ends to fit into an individual's mouth. The receptacles 90 and 92 collapse as the liquids are ingested. As illustrated, receptacles 90 and 92 are bound to each other at an area of adhesion 94. FIG. 14 illustrates a top plan view of the two receptacles 90 and 92, which have receptacle outlets 86 and 88, and which are joined into a unitary structure by an area of adhesion 94. The receptacles are of unequal size. FIG. 15 illustrates a cross-sectional side view of two collapsible pouch receptacles 101 and 103 containing a liquid medication 102, and a “wash-down” liquid beverage 104. This embodiment can be applied for masking undesirable tasting medication, particularly in “washing it down” immediately. This may be preferable, in some instances, to the conventional practice of taking a medication and then drinking a beverage from a separate glass, or cup. The medication is tasted in the interval between its ingestion and “washing down.”

While depicted as box-like, cup-like, or pouch-like embodiment in the accompanying drawings, a wide variety of shapes is possible for the receptacles, including sculpted or novelty shapes. It is understood that the walls of each receptacle has an inner aspect adjacent to the contained beverage and an outer aspect, a portion of which is directly or indirectly contiguous with another receptacle of the assemblage. The receptacles are made of material generally used to hold beverages, including, but not limited to plastic, glass, foil, and/or coated paper. Multi-layer material employing paper, poly and aluminum, such as manufactured by International Paper for aseptic packaging as “drink boxes” represent a preferred material and receptacle configuration. Pouches made of plastic and/or metallic laminate represent other favored materials and configurations. Such pouches may have a fixed structure, or, be collapsible.

It is preferred that the dimensions of the receptacles, in combination, be commensurate with the volume of liquid beverage ordinarily ingested by a child or adult within a short period of time, perhaps less than one hour, and commensurate with being comfortably held in one or both hands. Suggested ranges for total beverage is from 150 ml to 600 ml. Although it is considered that the receptacles preferably be of the same size, it might be desired for them to be of differing sizes, in which case, if fully filled in manufacture, one beverage would remain alone after the other is finished.

Opposition of receptacles may be accomplished by a combination of methods or by one method alone. It is considered that the receptacles are filled by a manufacturer for a user and are then sealed until use. A preferred type of receptacle and receptacle outlet is illustrated by the aseptic drink-box packaging type. The outlet of this type of package is opened by puncturing with a straw. Such packaging is produced by Tetra-Pak, Inc., Vernon Hills, Ill. It is anticipated that sealing of the outlets of the receptacles of the present invention might be in any form adaptable to beverages, including pull-tabs of the type commonly seen on aluminum soft drink containers, bottle caps, and screw tops. The outlet may be sealed with an adhered cover which can be punctured or stripped from the receptacle, as is known in the art. Another opening might be of the push-out type, such as those found in some coated-paper Tropicana orange juice containers produced by International Paper.

Each conduit is composed of a material rigid enough so that the conduit will not bend over from the force of gravity when standing on end. A plastic will provide the assemblage with a long useful life and a coated paper will provide the assemblage with a low manufacturing cost. Typically, the conduits will have the same length. The length of one or more may be shortened in order to customize the assemblage for a particular use. The cross-sectional shape may be formed into any desired shape, but is typically round. The cross-sectional area of the conduits are typically the same, but can be formed to regulate the amount of each liquid reaching the mouth at the same time or to accommodate liquids of differing densities. Optionally, the cross-sectional area can be controlled dynamically by pinching the conduit walls. In this way, the proportion of liquids reaching the mouth can be changed dynamically to accommodate the tastes of the drinker.

The conduits may be longitudinally rigid or mechanically deformable by applying force. In the rigid embodiment, the conduit will maintain its longitudinal shape under a moderate amount of stress. In one deformable embodiment, the conduit does not maintain the deformed shape after the force is removed. In another deformable embodiment, the deformed shape is maintained. One way to maintain the deformed shape is to provide the conduit with a bellows, a device well known in the art. Suitable conduit length from the furthest interior of the receptacle to its outlet and some measure to fit into the mouth, is preferably accomplished without crossing of the conduits. Particularly long conduit lengths are considered ordinarily less desirable because of the additional effort required to the draw two liquids a greater distance.

To further define the invention, the following beverages exemplify combinations of the present invention.

### EXAMPLE 1

Beverage #1: Chocolate milk-based drink

Beverage #2: Cherry flavored fruit drink

In a market study, 14 children, age range 8-12, were exposed to the concept of “mixing drinks in your mouth.” The younger children expressed a strongly positive response, and thought that drinking beverages in this manner would be “fun.” Older subjects responded less positively to the “fun” or novelty value of the concept as relating to themselves. Upon tasting this beverage combination in the manner described, however, there was a surprising unanimity of strongly positive response. Interestingly, pre-teen subjects who registered little support for the notion, expressed surprise at tasting this beverage and stated that they would like to buy it.

Having tasted this beverage, each subject explained the concept to a parent, all with strong enthusiasm. Parents' first impression was that they would buy the beverage for the children, if they would drink it. Holding this combination in favor for their children as a method of encouraging consumption of milk and fruit juice rather than less nutritious alternatives, but weren't interested in purchasing it for themselves. When encouraged (almost coerced, in some cases) by their children to try the drink, many parents registered surprise at how good it tasted and some stated that they would indeed drink it themselves if it were commercially available.

Notably, this combination combines two different flavors and two textures: the watery consistency of the fruit juice and the creamy consistency of milk. It is perceived, that when ingested simultaneously, each flavor, cherry and chocolate, is tasted undiluted, and the consistency of juice and of creamy milk are experienced undiluted. In a double-blinded study in a second cohort of 10 children, to whom the concept was not explained, the majority of subjects perceived a difference, and preferred drinking these beverages simultaneously rather than mixed.

### EXAMPLE 2

Beverage 1: Carrot juice

Beverage #2: Pineapple juice

This combination was tested to attempt combine a fruit and a vegetable juice and was intended to appeal to health-aware adults. In preliminary testing this particular combination was thought to have an interesting taste. In market testing of 23 subjects, it was highly rated by both adults and children. When subjects compared tasting the components simultaneously to mixed together, the majority of subjects found that the individual tastes were more defined and preferred drinking the components simultaneously.

### ADDITIONAL EXAMPLES

Beverage #1: Orange juice

Beverage #2: Milk

Representative of another milk and fruit juice combination.

Beverage #1: Coffee with sweetener

Beverage #2: Chocolate milk

Representative of an adult drink combination.

Beverage #1: Tea with sweetener

Beverage #2: Lemonade

Representative of another adult drink combination.

Beverage #1: Carbonated cola beverage

Beverage #2: Cherry flavored beverage (carbonated or non-carbonated)

Representative of a combination of beverages which includes a carbonated beverage.

Beverage #1: Chocolate milk

Beverage #2: Strawberry milk

Representative of a beverage combination comprising same textured and different flavored beverages.

Beverage #1: Root beer

Beverage #2: Milk

Representative of a combination of beverages which includes different textures and flavors. The milk component may be additionally sweetened and/or flavored.

The foregoing examples are not intended to be inclusive but rather exemplary of beverage combinations, and illustrative of the qualitative advantages of the present invention. Additional beverage flavors include fruit flavors: apple, apricot, blueberry, blackberry, cantaloupe, grape, grapefruit, honeydew, mango, lemon, lime, nectarine, papaya, peach, plum, and watermelon; vegetable flavors: celery, carrot, beet, and tomato; flavors commonly associated with carbonated beverages: cola, birch beer, creme, root beer; milk-based beverages including plain, banana and strawberry milk, and additional flavors: butterscotch, cinnamon, nutmeg, and quinine. Combinations of these may be found considerably different when discretely ingested together, compared to being ingested mixed, and are considered within the scope of the invention. The selection of beverages to simultaneously and complementarily stimulate known taste bud receptor modalities of sweet, sour, salty, and bitter are also considered.

Thus it has been shown and described a drinking assemblage and beverages which satisfy the objects set forth above. Since certain changes may be made in the present disclosure without departing from the scope of the present invention, it is intended that all matter described in the foregoing specification or shown in the accompanying drawings, be interpreted as illustrative and not in a limiting sense.

What is claimed is:

1. A drinking assemblage for enabling a person to ingest streams of potable or medicinal liquids simultaneously from a plurality of receptacles into a plurality of oral locations, said kit comprising:
a plurality of liquid beverage-containing receptacles having an outlet, said receptacles each being pre-filled with a different liquid and each being pre-sealed;
a joining mechanism joining said receptacles to each other; and
a plurality of conduits wherein said receptacles, said joining mechanism and said conduits being of complementary dimensions such that, when assembled, said conduits can reach longitudinally from the furthest dependant interiors of the receptacles, and be comfortably positioned to fit into a plurality of locations within said person's mouth.

2. The drinking assemblage of claim 1 wherein said joining mechanism is a joining structure.

3. The drinking assemblage of claim 1 wherein said joining mechanism is can adhesive layer.

4. The drinking assemblage of claim 1 wherein said joining mechanism are one or more peripheral bands.

5. The drinking assemblage of claim 1 wherein said joining mechanism is material wrap.

6. The drinking assemblage of claim 1 wherein said joining mechanism is a common wall separating said receptacles.

7. The drinking assemblage of claim 1 wherein one of said liquid has a creamy texture and another has a watery texture.

8. The drinking assemblage of claim 1 wherein two of said liquids have a creamy texture.

9. The drinking assemblage of claim 1 wherein two of said liquids have a watery texture.

10. The drinking assemblage of claim 1 wherein one of said liquids is milk-based and another is fruit juice based.

11. The drinking assemblage of claim 1 wherein one of said liquids is a fruit juice and another is a vegetable juice.

12. The drinking assemblage of claim 1 wherein at least one of said liquids is carbonated.

13. The drinking assemblage of claim 1 wherein at least one of said liquids is medicinal.

14. A method for enabling a person to ingest streams of potable or medicinal liquids simultaneously from a plurality of receptacles into a plurality of oral locations, said method comprising:
providing a plurality of beverage-containing receptacles which are pre-filled and pre-sealed and which have an outlet; and
providing a joining mechanism to hold said receptacles in close proximity to each other; and
providing a plurality of conduits, each having an ingress, and an egress, said receptacles, said joining mechanism and said conduits being of complementary dimensions such that, when assembled, said conduits can reach longitudinally from the furthest dependent interiors of the receptacles, and be comfortably positioned to fit into a plurality of locations within said person's mouth.

15. A method for enabling a person to ingest streams of potable or medicinal liquids simultaneously from a plurality of receptacles into a plurality of oral locations, said method comprising:
obtaining a kit comprising: a plurality of beverage-containing receptacles which are pre-filled and pre-sealed for a user and which have an outlet; a joining mechanism to join said receptacles to each other; and a plurality of conduits, each having an ingress, and an egress; said receptacles, said joining mechanism and said conduits being of complementary dimensions such that, when the receptacles are joined and the conduits are inserted through the outlets of the receptacles, said receptacles, said joining mechanism, and said conduits allow the ingresses of said conduits to reach from the furthest dependent interiors of the receptacles, and the egresses to be comfortably be positioned to fit into a plurality of locations within the user's mouth; and
drinking said liquids together.
